(19) United States
(12) Patent Application Publication
(10) Pub. No.: US 2026/0265114 A1
(43) Pub. Date: Sep. 10, 2026

(54) HOLLOW CORE OPTICAL FIBRE DRAWING METHOD WITH MODIFIED PREFORM

(71) Applicant: University of Southampton, Redmond, WA (US)

(72) Inventors: Gregory Teofil JASION, Redmond, WA (US); Andrew Thomas HARKER, Redmond, WA (US); Francesco POLETTI, Redmond, WA (US)

(73) Assignee: University of Southampton, Redmond, WA (US)

(21) Appl. No.: 18/993,665

(22) PCT Filed: Jun. 16, 2023
(86) PCT No.: PCT/US2023/025499

§ 371 Date: Jan. 13, 2025

(30) Foreign Application Priority Data
Jul. 14, 2022 (GB) 2210360.0

(51) Int. Cl. C03B 37/027; G02B 6/02

(52) U.S. Cl. CPC C03B 37/02781; G02B 6/02328; C03B 2203/16

(57) ABSTRACT

A method of fabricating a hollow core optical fibre comprises: providing a thin preform formed from glass and having a transverse cross-sectional structure configured to form, in a hollow core optical fibre drawn from the thin preform, a transverse cross-sectional structure comprising a hollow core surrounded by a plurality of voids defining a microstructured cladding, the thin preform have a width in the range of 0.5 to 5 mm and a total length available for drawing into the hollow core optical fibre; heating an end portion of the thin preform in order to soften the glass of the end portion; and drawing a length of hollow core optical fibre from the softened glass of the thin preform, the hollow core optical fibre having a width less than the width of the thin preform.

### BACKGROUND OF THE INVENTION

The present invention relates to a method for drawing hollow core optical fibres, comprising modifications compared to conventional methods.

Optical fibres conventionally are of a solid core design, comprising a core of solid glass surrounded by a cladding of solid glass of a lower refractive index than the core. Light is guided along the core by total internal reflection at the core-cladding boundary. Solid core fibres are fabricated by a fibre drawing process, in which a short rigid glass preform having a cross-sectional structure matching the intended refractive index profile of the finished fibre, but with a width many times that of the finished fibre, is lowered axially into an annular furnace which heats and softens the glass. The softened glass is then pulled or drawn from an end of the preform, either under gravity or with tensioning, to a decreased width for the finished fibre, which is wound onto a spool. In some processes, a cane of narrower width and a few metres in length is firstly drawn from the preform, and separated from the preform to be drawn into the fibre at a later time. The process of drawing from a preform to a cane or a fibre, and from a preform or a cane to a fibre, to narrow the width of the glass structure, is referred to as drawdown. Fibre drawing can be described by a parameter known as the drawdown ratio, being the ratio of the width or cross-sectional area of the preform to the width or cross-sectional area of the finished fibre. Another relevant parameter is known as the fibre yield ratio, being the number of metres of fibre that can be drawn per metre of preform. Desirably this has a high value, both to access long fibre lengths, and to increase fibre fabrication efficiency. Commercially, the total continuous length of fibre that can be produced in a single draw has increased over several decades from a few tens of kilometres to lengths of the order of 10,000 km. This increase has been largely achieved by increasing the preform size so that a larger initial volume of glass is available to be converted into fibre. The cross-sectional area of preforms has been increased by around thirty times, giving a corresponding increase in preform width, with a modest increase in preform length to around three metres. Hence, both the drawdown ratio and the field yield ratio have been significantly increased, attained by a greatly increased preform width while the preform length is kept relatively short.

In recent years, hollow core optical fibres have been developed. These have a central longitudinal hole or void defining a hollow core, which is surrounded by a cladding typically comprising a plurality of smaller longitudinal holes or voids in a specified geometry, which may be referred to as a microstructure. Light is guided along the hollow core by one of several mechanisms, depending on the geometry of the microstructured cladding. Hollow core fibres are attractive owing to superior optical propagation characteristics compared with solid core fibres, including reduced optical propagation loss (attenuation), increased propagation speed, larger optical bandwidth and reduced parasitic nonlinear optical effects, which stem from the large fraction of air inside the fibre and corresponding reduced amount of glass. Light propagates mainly in air, thereby avoiding detrimental effects arising from propagation in glass. Hollow core fibres can also be made by fibre drawing methods, starting from a preform (optionally drawn into a cane) formed with the desired cross-sectional profile of voids. In order to achieve the desired geometrical structure of the core and cladding in the finished fibre (which needs to be precise for position, void size, and thickness of glass membranes between voids) for accessing the intended optical properties of the particular fibre design, pressure is applied to the voids during drawing of the fibre from the preform or the cane. The pressurisation counteracts surface tension in the softened glass which otherwise tends to cause collapse of the voids and destruction of the intended structure.

Fibre yield ratio and drawdown ratio are also relevant to the drawing of hollow core fibre. As with solid core fibres, an overall larger hollow core preform contains a larger volume of glass so would be expected to yield more fibre. For example, the preform width may be increased [1], which demands a higher drawdown ratio to produce the same width of fibre. For hollow core fibres, however, the dynamics of the pressurisation are more complex and difficult to control when drawing a wide preform into a narrow fibre via a large drawdown ratio, since the changes in the outer diameter and the diameter of the holes are more extreme. Accordingly, high drawdown ratios are typically unsuitable or even unachievable for hollow core fibre fabrication. Hence, a narrower preform and correspondingly lower drawdown ratio are generally required for successful hollow core fibre fabrication, giving a smaller yield ratio and corresponding inefficiency in fibre production. However, pressurisation can be more difficult to implement with a narrower preform since the voids are smaller and harder to access; this can decrease the structural quality of the finished fibre. Hence there are a number of factors which inhibit efficient high volume fabrication of quality hollow core optical fibre. Reported single spans of hollow core fibre with reasonable propagation loss figures of which the inventors are aware are relatively short, at 12 km (4-5 dB/km loss) [2] and 14 km (10 dB/km loss) [3], while shorter lengths of 10 km or less are more common with current hollow core fibre drawing methods. The cost of hollow core fibre is therefore high and maximum achievable lengths of fibre are greatly limited compared with solid core fibre. These factors are particularly detrimental in view of the excellent optical properties of hollow core fibres which make them highly attractive for many applications, including long-distance telecommunications for which very long lengths of inexpensive fibre are desirable. Hence there are a range of difficulties in hollow core optical fibre production that tend to limit achievable fibre length, reduce efficiencies, and increase complexity and cost.

Accordingly, approaches that improve the fabrication of hollow core optical fibres are of interest.

### SUMMARY OF THE INVENTION

Aspects and embodiments are set out in the appended claims.

According to a first aspect of certain embodiments described herein, there is provided a method of fabricating a hollow core optical fibre, the method comprising: providing a thin preform formed from glass and having a transverse cross-sectional structure configured to form, in a hollow core optical fibre drawn from the thin preform, a transverse cross-sectional structure comprising a hollow core surrounded by a plurality of voids defining a microstructured cladding, the thin preform have a width in the range of 0.5 mm to 5 mm and a total length available for drawing into the hollow core optical fibre; heating an end portion of the thin preform in order to soften the glass of the end portion; and drawing a length of hollow core optical fibre from the softened glass of the thin preform, the hollow core optical fibre having a width less than the width of the thin preform.

According to a second aspect of certain embodiments described herein, there is provided a method for fabricating a preform for a hollow core optical fibre, the method comprising: providing an initial preform formed from glass and having a transverse cross-sectional structure configured to form, in a thin preform drawn from the initial preform, a transverse cross-sectional structure able to be drawn from the thin preform into a hollow core optical fibre having a transverse cross-sectional structure comprising a hollow core surrounded by a plurality of voids defining a microstructured cladding, the initial preform having an initial preform width; applying pressurisation to voids in the initial preform; heating an end portion of the initial preform in order to soften the glass of the end portion of the initial preform; and drawing a thin preform from the softened glass of the initial preform while the pressurisation is applied, the thin preform having a width less than the initial preform width and in the range of 0.5 mm to 5 mm.

According to a third aspect of certain embodiments described herein, there is provided a thin preform formed from glass and having a transverse cross-sectional structure configured to form, in a hollow core optical fibre drawn from the thin preform, a transverse cross-sectional structure comprising a hollow core surrounded by a plurality of void defining a microstructured cladding, the thin preform have width in the range of 0.5 mm to 5 mm, and a length of at least 30 m.

According to a fourth aspect of certain embodiments described herein, there is provided a hollow core optical fibre having a transverse cross-sectional structure comprising a hollow core surrounded by a plurality of voids defining a microstructured cladding, the hollow core optical fibre having a length of at least 20 km.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, methods and devices may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a transverse cross-sectional view of a first example hollow core optical fibre which may be fabricated according to example methods of the present disclosure;

FIG. 2 shows a transverse cross-sectional view of a second example hollow core optical fibre which may be fabricated according to example methods of the present disclosure;

FIG. 3 shows a transverse cross-sectional view of a third example hollow core optical fibre which may be fabricated according to example methods of the present disclosure;

FIG. 4 shows a flow chart of steps in an example hollow core optical fibre drawing method according to an aspect of the present disclosure;

FIG. 5 shows a flow chart of steps in an example thin preform drawing method according to an aspect of the present disclosure;

FIGS. 6A and 6B show schematic representations of example apparatus suitable for carrying out an example method of fabricating a hollow core optical fibre in accordance with the following disclosure in which a thin preform is provided according to a first alternative;

FIG. 7 shows a schematic representation of example apparatus suitable for carrying out an example method of fabricating a hollow core optical fibre in accordance with the following disclosure in which a thin preform is provided according to a second alternative; and

FIG. 8 show a schematic representation of example apparatus suitable for carrying out an example method of fabricating a hollow core optical fibre in accordance with the following disclosure in which a thin preform is provided according to a third alternative.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of devices and methods discussed herein which are not described in detail may be implemented in accordance with any conventional techniques for implementing such aspects and features.

The present disclosure proposes methods for the fabrication of hollow core optical fibres aimed at addressing some of the issues with known methods with a view to upscaling output and improving fibre yield.

Hollow core optical fibre has a core in which light is guided that comprises a central longitudinal hole or void (commonly filled with air, but alternatively with another gas or mixture of gases, or a vacuum), surrounded by a cladding comprising a structured arrangement of longitudinal holes, voids or capillaries extending along the fibre length (microstructure). The absence of a solid glass core reduces the proportion of a guided optical wave that propagates in glass compared to that in a solid core fibre, offering benefits such as increased propagation speed, reduced loss from both absorption and scattering, and reduced nonlinear interactions. These properties make hollow core optical fibre very attractive for use in many applications. These include optical telecommunications systems. However, it is presently very difficult to manufacture hollow core optical fibre in the long lengths which are desirable for telecommunications systems, in which data centres between which optical data is transmitted may be tens or hundreds of kilometres apart. Typically, lengths of only about 10 km are achievable.

Hollow core optical fibres can be categorised according to their mechanism of optical guidance into two principal classes or types: hollow core photonic bandgap fibre (HCPBF, alternatively often referred to as hollow core photonic crystal fibre, HCPCF), and antiresonant hollow core fibre (AR-HCF or ARF). There are various subcategories of ARFs characterised by their geometric structure, including kagome fibres, nested antiresonant nodeless fibres (NANFs) and tubular fibres. The present disclosure is applicable to all types of hollow core fibre, including these two main classes and their associated sub-types plus other hollow core designs. Note that in the art, there is some overlapping use of terminologies for the various classes of fibre. For the purposes of the present disclosure, the terms “hollow core optical fibre” and “hollow core fibre” are used interchangeably and intended to cover all types of these fibres having a hollow core as described above. The terms “HCPBF” and “HCPCF” are used to refer to hollow core fibres which have a structure that provides waveguiding by photonic bandgap effects (described in more detail below). The terms “ARF” and “antiresonant hollow core fibre” are used to refer to hollow core fibres which have a structure that provides waveguiding by antiresonant effects (also described in more detail below).

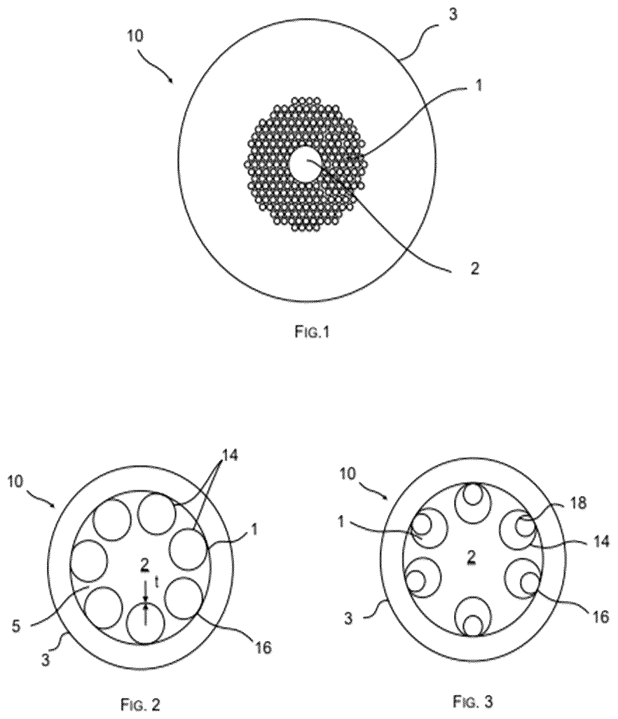

FIG. 1 shows a schematic transverse cross-sectional view of an example HCPBF 10. In this fibre type, a structured, inner, cladding 1 comprises a substantially regular closely packed array of many small glass capillaries, from which a central group is excluded to define a substantially circular hollow core 2. The periodicity of the cladding structure provides a periodically structured refractive index and hence a photonic bandgap effect that confines the propagating optical wave towards the core. This is the fundamental optical mode or fundamental mode (FM). One or more higher-order optical modes or higher-order modes (HOMs) may be supported in the core 2 and/or the cladding 1. These fibres can be described in terms of the number of cladding capillaries or “cells” which are excluded to make the core 2. In the FIG. 1 example, the central nineteen cells from the array are absent in the core region, making this a 19-cell core HCPBF. The structured cladding 1 is formed from six rings of cells surrounding the core 2, plus some cells in a seventh ring to improve the circularity of the outer surface of the cladding. An outer cladding or jacket 3 surrounds the structured cladding 1.

In contrast to HCPBF, antiresonant hollow core fibres guide light by an antiresonant optical guidance effect. The structured cladding of ARFs has a simpler configuration, comprising a much lower number of larger glass capillaries or tubes than a HCPBF, to give a structure lacking any high degree of periodicity so that photonic bandgap effects are not significant. Rather, antiresonance is provided for propagating wavelengths which are not resonant with a wall thickness of the cladding capillaries, in other words, for wavelengths in an antiresonance window which is defined by the cladding capillary wall thickness. The cladding capillaries surround a central void or cavity which provides the hollow core of the fibre, and which is able to support antiresonantly-guided optical modes, comprising the fundamental mode and one or more higher-order modes. The structured cladding can also support cladding modes able to propagate primarily inside the capillaries, in the glass of the capillary walls or in the spaces or interstices between the cladding capillaries and the fibre's outer cladding. The loss of these additional higher-order non-core guided modes is generally very much higher than that of the core guided modes. The fundamental core guided mode typically has by far the lowest loss amongst the core guided modes. The antiresonance provided by a capillary wall thickness which is in antiresonance with the wavelength of the propagating light acts to inhibit coupling between the fundamental core mode and any cladding modes, so that light is confined to the core and can propagate at very low loss.

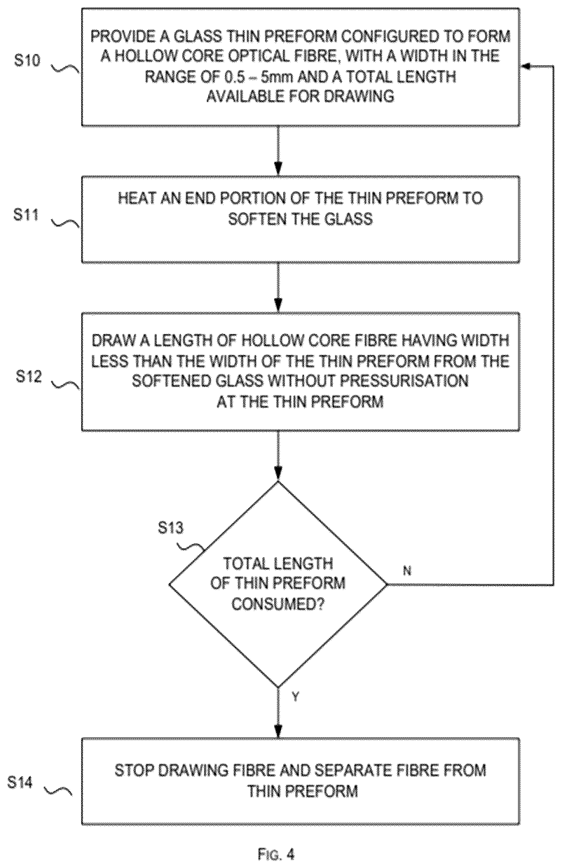

FIG. 2 shows a schematic transverse cross-sectional view of an example simple antiresonant hollow core fibre. The fibre 10 has an outer tubular cladding or jacket 3. A structured, inner, cladding 1 comprises a plurality of tubular cladding capillaries 14, in this example seven capillaries of the same cross-sectional size and shape, which are arranged inside the outer cladding 3 in a single ring, so that the longitudinal axes of each cladding capillary 14 and of the outer cladding 3 are substantially parallel. Each cladding capillary 14 is in contact with (bonded to) the inner surface of the outer cladding 3 at an azimuthal location 16, such that the cladding capillaries 14 are evenly spaced around the inner circumference of the outer cladding 3, and are also spaced apart from each other by gaps 5 (there is no contact between neighbouring capillaries). In some designs of ARF, the cladding tubes 14 may be positioned in contact with each other (in other words, not spaced apart as in FIG. 2), but spacing to eliminate this contact improves the fibre's optical performance and is generally preferred. The spacing 5 removes nodes that arise at the contact points between adjacent tubes and which tend to cause undesirable resonances that result in high losses. Accordingly, fibres with spaced-apart cladding capillaries may be referred to as “nodeless antiresonant hollow core fibres”.

The arrangement of the cladding capillaries 14 in a ring around the inside of the tubular outer cladding 3 creates a central space, cavity or void within the fibre 10, also with its longitudinal axis parallel to those of the outer cladding 3 and the capillaries 14, which is the fibre's hollow core 2. The core 2 is bounded by the inwardly facing parts of the outer surfaces of the cladding capillaries 14. This is the core boundary, and the material (glass or polymer, for example) of the capillary walls that make up this boundary provides the required antiresonance optical guidance effect or mechanism. The capillaries 14 have a thickness t at the core boundary which defines the wavelength bandwidth for which antiresonant optical guiding occurs in the ARF.

FIG. 2 shows merely one example of an ARF, and many other ARF structures are known.

FIG. 3 shows a schematic transverse cross-sectional view of a second example ARF. The ARF has a structured inner cladding 1 comprising six cladding capillaries 14 evenly spaced apart around the inner surface of a tubular outer cladding 3 and surrounding a hollow core 2. Each cladding capillary 14 has a secondary, smaller capillary 18 nested inside it, bonded to the inner surface of the cladding capillary 14, in this example at the same azimuthal location 16 as the point of bonding between the primary capillary 14 and the outer cladding 3. These additional smaller capillaries 18 can reduce the optical loss. Additional still smaller tertiary capillaries may be nested inside the secondary capillaries 18. ARF designs of this type, with secondary and optionally smaller further capillaries, may be referred to as “nested antiresonant nodeless fibres”, or NANFs, where “double nested antiresonant nodeless fibre” or DNANF refers to fibres including tertiary nested capillaries.

Many other capillary configurations for the structured cladding of an ARF are possible, and the disclosure is not limited to the examples described above. For example, the capillaries need not be of circular cross-section, and/or may or may not be all of the same size and/or shape. The number of capillaries surrounding the core may be for example, four, five, six, seven, eight, nine or ten, although other numbers are not excluded. The ring of cladding capillaries in an ARF creates a core boundary which has a shape comprising a series of adjacent inwardly curving surfaces (that is, convex from the point of view of the core). This contrasts with the usual outward curvature of the core-cladding interface in a conventional solid core fibre, and the substantially circular core boundary of a HCPBF (see FIG. 1). Accordingly, antiresonant hollow core fibres can be described as negative curvature fibres. The kagome category of ARF can also be configured as negative curvature fibres, and has a structured cladding of multiple small capillaries in an array, similar to HCPBF, but not configured to provide photonic bandgaps. In contrast to HCPBF, the guidance mechanism operates by antiresonance effects. Other examples of ARF include designs having claddings formed as a conjoined tube structure and a hemispherical tube structure [5].

Herein, the terms hollow core optical fibre, hollow core fibre, hollow core waveguide, hollow core optical waveguide and similar terms are intended to cover optical waveguiding structures configured according to any of the above examples and similar structures, where light is guided by any of several guidance mechanisms (photonic bandgap guiding, antiresonance guiding, and/or inhibited coupling guiding) in a hollow elongate void or core surrounded by a structured cladding comprising a plurality of longitudinal capillaries. The capillaries comprise or define elongate holes, voids, lumina, cells or cavities which run continuously along the length or longitudinal extent of the optical fibre, substantially parallel to the elongate core which also extends continuously along the fibre's length. These various terms may be used interchangeably in the present disclosure.

The hollow core fibre fabrication methods proposed herein are applicable to all and any types of hollow core optical fibre, as described above. The proposed methods can improve hollow core fibre fabrication yield for all fibre types, and order or orders of magnitude improvement in yield are enabled, offering continuous lengths of hollow core fibre in excess of 100 km. This will allow the commercial adoption of hollow core fibres for new application, and in particular will improve optical fibre telecommunications links, enabling for example trans-oceanic hollow core optical fibre links. At present, a link of 100 km length is considered ambitious and must be assembled from multiple short lengths of hollow core fibre, which requires significant resources.

The proposed methods utilise modifications to a fibre drawing process that enable hollow core fibre fabrication with a greatly enhanced output yield in terms of continuous length of fibre than is conventionally achievable.

The proposed methods are modified compared to a conventional drawing process by the introduction of a modified, narrower preform with a width between that of a conventional hollow core preform and the finished fibre. The narrow or thin preform has a smaller width than a conventional cane and unlike a cane is not separated in short lengths from the originating preform from which it is drawn. The thin preform is able to be drawn into fibre without the application of pressure to its voids during drawing, also unlike a conventional a cane. The narrow width of the thin preform gives a relatively small drawdown ratio from preform to fibre, which avoids the need for dedicated pressurisation. Also, the thin preform has a very long total length and hence a large total glass volume, so that a greatly increased continuous length of fibre may be drawn from it. Hence, a high total yield of fibre is enabled, even though the yield ratio and the drawdown ratio from thin preform to fibre are low (owing to the long length and small width of the preform). The long length of the thin preform may be produced in its entirety from an initial preform before fibre drawing, or it may be produced simultaneously with the fibre drawing such that the thin preform has a transient length which is replenished at a first end (which in some configurations may be an upper end) by drawing from the initial preform simultaneously with being consumed at a second end) which in some configurations may be a lower end) by being drawn to fibre, the transient length accumulating over time to give the total long length.

The absence of pressurisation is not only convenient, it also addresses a particular problem that limits the ability to draw hollow optical fibre from a conventional preform via a relatively large drawdown ratio. As discussed above, current hollow core optical fibre designs, including HCPBF and ARF, require the application of pressure to the voids in the preform or cane during drawing of the fibre from that preform or cane. The pressurisation is often differential, in that two or more different pressures are applied to different voids. The pressures are required to counteract surface tension in the softened glass during drawing, which acts to collapse the voids, thereby altering or destroying the intended fibre structure if not checked. Adjustment of the pressure(s) can precisely control the final geometry of the fibre. During drawing, the glass structure undergoes a geometry change which is termed neckdown. This is a narrowing of the glass structure where it is softened and made plastic (so that it is pliable or ductile) within the draw furnace, the width continuously decreasing over a length of the structure from the width of the preform or cane to the intended width of the fibre. When pressurisation is implemented, at the wider end of the neckdown (closest to the pressure input at the open, non-drawn, end of the preform or cane, and typically an upper end since fibre drawing is commonly carried out vertically) the geometry is dominated by the applied pressure. At the narrower end of the neckdown, where the fibre forms, the geometry is dominated by surface tension in the softened glass, which causes capillary contraction. Hence, an interplay exists between the forces of the applied pressures and the surface tension, and in order to achieve a desired capillary size and membrane thickness it is necessary to apply sufficient pressure that the capillary initially expands beyond the required size, in order that later contraction under the surface tension at the lower end of the neckdown pulls the capillary back to the target size.

Attempts to increase the fibre yield ratio of a draw by using a wider preform or cane to increase the drawdown ratio so that more fibre can be produced from a preform or cane increases the complexity of the pressure-surface tension relationship and makes identifying the correct parameters for drawing more difficult. Eventually, the contraction phase of the draw dynamics becomes very aggressive, and increased capillary expansion under higher applied pressures is required to counteract it. However, within the glass structure, there is limited room for expansion of the capillaries, and there comes a point where the expansion overshoot required to pre-empt the contraction causes unacceptable deformations in the fibre structure. In particular, contact between neighbouring capillaries in an ARF design in which the capillaries should be spaced apart may occur, causing the capillaries to fuse together. In a HCPBF design, gross asymmetry of the hollow core can occur. Such defects are highly adverse to the optical properties and performance of the finished fibre, so need to be avoided. For convenience, the phenomenon may be termed mid-draw contact (MDC), and is a significant limiting factor in attempts to increase fibre yield ratios for hollow core fibre production. If the proposed drawdown ratio from preform/cane to fibre is greater than the limits imposed by MDC, the intended fibre cannot be made.

As a preliminary to discussing the invention in detail, some terms relevant to fibre drawing will be discussed and defined. In optical fibre fabrication, a preliminary step is the formation of a relatively large cylindrical glass structure, referred to as a preform. For a hollow core optical fibre, the preform has a cross-sectional structure containing glass elements that will, once drawn, form the structural elements required in the finished fibre, where fusion, expansions and contractions of the glass elements that occur during drawing are taken into account in the preform structure so that the final fibre structure is as intended. A preform is made by assembling its constituent glass elements into the appropriate arrangement. For a hollow core fibre, a preform is typically made by stacking a plurality of capillary tubes that will define the fibre cladding inside an outer glass tube that supports the cladding tubes, possibly with spacer elements to retain the capillary tubes in position. Bonding of the elements may be carried out to fix the capillary tubes in place relative to the outer tube, or the bonding may occur as part of the draw process. The preform may be drawn directly into the intended fibre. Alternatively, in conventional methods the preform may be drawn into one or more separate canes, which have a width intermediate between the preform and the intended fibre, and a length of around one metre, for example. The canes may then each be drawn into separate lengths of the intended fibre. Canes may be simpler to handle than the preform, and also reduce the drawdown ratio for drawing into the fibre. The terms preform and cane tend to be used interchangeably to some extent, however, and hence requires some clarification in the present context. A preform can be considered as any glass structure that can be drawn into a narrower structure (it is a pre-form of the form of the narrower structure). Under this definition, a preform made by stacking or other assembling of glass elements which is to be drawn into a cane or a fibre constitutes a preform, but similarly a cane can be considered to be a preform in that it can be drawn into a narrower cane or into a fibre. A cane is similarly a glass structure that can be drawn into a narrower structure (narrower cane or fibre), but it has been formed by being drawn from a wider glass structure, rather than by assembling the separate elements. In the presently proposed methods, an intermediate glass structure of width between that of a preform and the finished fibre is used, but has a number of characteristics that distinguish it from a conventional cane. Accordingly, the term “cane” will not be used in the following description to denote this intermediate structure. The term “initial preform” will be used to denote an initial glass structure from which the intermediate glass structure is fabricated, with the understanding that it may comprise either a preform made by assembling glass elements into a required structure, or a cane which has been drawn from such a preform. The term “thin preform” will be used to denote the glass structure of intermediate width which is drawn from the initial preform, and in turn drawn into the fibre, with the descriptor “thin” indicating a reduced width compared to a conventional preform or cane that is drawn directly into fibre. The thin preform is also long, as compared to a conventional preform or cane that is drawn directly into fibre. In different examples of the proposed method, the long length may be fabricated in a single stage in advance of fibre drawing from the thin preform, or may be accumulated or replenished “on the fly” at the same time as fibre is drawn from the thin preform. The term “fibre” is used conventionally to denote optical fibre which is drawn from the thin preform. The method comprises drawing the fibre from the thin preform, and may additionally include drawing the thin preform from the initial preform.

The initial preform has an initial preform width or diameter (first width) and an initial preform cross-sectional area (first cross-sectional area), the thin preform has a thin preform width or diameter (second width) less than the initial preform width and a thin preform cross sectional area (second cross-sectional area) less than the initial preform cross-sectional area, and the fibre has a fibre width or diameter (third width) less than the thin preform width and a fibre cross-sectional area (third cross-sectional area) less than the thin preform cross-sectional area. Fabrication of the fibre by drawing from the thin preform has a drawdown ratio which may be defined as the ratio of the thin preform width to the fibre width, or the ratio of the thin preform cross-sectional area to the fibre cross-sectional area. Fabrication of the thin preform from the initial preform has a drawdown ratio that is the ratio of the initial preform width to the thin preform width, or the ratio of the initial preform cross-sectional area to the initial preform cross-sectional area. An overall drawdown ratio may be the ratio of the initial preform width to the fibre width, or the ratio of the initial preform cross-sectional area to the fibre cross-sectional area. When calculating drawdown ratios, the relevant width and relevant cross-sectional area is the outer diameter and area of the cladding in the fibre, or of the glass elements in the initial preform and the thin preform that will form the cladding in the fibre, and excludes any supporting and/or protecting layers around the cladding.

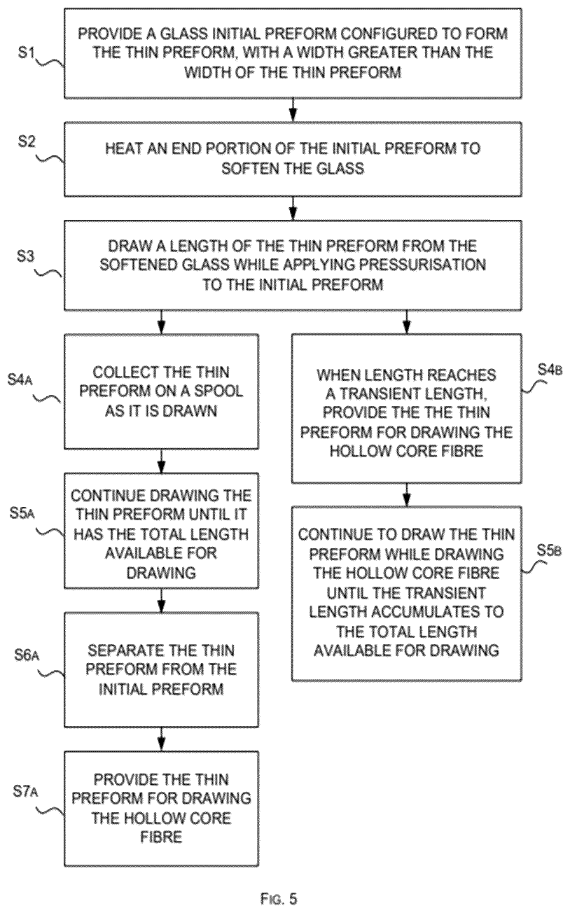

FIG. 4 shows a flow chart of steps in an example method for fabricating hollow core optical fibre according to the disclosure. In a first step S10, a thin preform made from glass is provided, from which the hollow core optical fibre will be drawn. As described above, the thin preform has a transverse cross-sectional structure which is configured to form the required transverse cross-sectional structure of the desired hollow core fibre type and design, after drawing of the thin preform into a fibre of the desired width. The thin preform structure is configured such that the hollow core fibre can be drawn from it without the need to apply pressurisation to the voids of the thin preform during drawing of the fibre. This is achievable if a relatively small drawdown ratio is used to draw the fibre; hence the requirement that the thin preform is thin, where the thinness can be understood as relative to a typical width of a preform or cane from which a hollow core fibre is drawn directly in a conventional process, where pressurisation is required to counteract surface tension contraction of the softened glass as discussed above. When drawing a thin preform into a fibre, with a low drawdown ratio, the surface tension contraction is less aggressive and pressurisation may not be required to balance it. Hence, there is no expansion of the elements in the glass structure that is caused by applied pressure, and the risk of MDC is avoided. However, in a thin preform, surface tension will still be present in the molten glass so that some contraction occurs during drawing of the fibre. In order to arrive at the target dimensions in the fibre's internal structure, this can be accounted for by appropriate configuration of the internal structure of the thin preform. In the absence of any forces from applied pressure (causing expansion) and surface tension (causing contraction), a drawn hollow core fibre would preserve the proportions and geometric ratios of the structure of the preform from which it is drawn; only the scale would be reduced, by an amount that can be controlled by parameters of the fibre drawing such as the speed and tensioning. In the present case, some surface tension will be present, however. In order to account for this, the thin preform can be structured accordingly so that the dimensions of parts that will contract under surface tension are made proportionately larger, in order to compensate for the contraction. Hence, the thin preform can have a cross-sectional structure with a geometric ratio for the various elements that corresponds to the intended geometric ratio for the hollow core fibre plus a compensating amount or amounts (where different elements may require different amounts of compensation if they experience different surface tensions, such as owing to different diameters or membrane thicknesses) sized to balance surface tension contraction of the softened glass of the thin preform during drawing of the hollow core fibre. The compensation may need to be only a few percent in size owing to the small drawdown ratio to be used to draw the fibre. Hence, some or all internal elements (such as hollow tubes or capillaries) may exceed the size required by match the geometric ratio for the hollow core fibre by 10% or less, or 5% or less, or 3% or less, for example.

The thin preform has a width in the range of 0.5 mm to 5 mm. Under some circumstances a larger minimum width may be more suitable, such as ease of handling the thin preform, so that the range may alternatively be 1 mm to 5 mm, for example. Similarly, a smaller maximum width may be more suitable in other circumstances, such as avoidance of mid draw contact, or a requirement for bending or winding the thin preform, so that range may alternatively be 0.5 mm to 3.5 mm, or 0.5 mm to 2.5 mm, for example. Overall, then, a smaller range of thin preform width around 1 mm to 2.5 mm might be defined according to requirements of a particular fabrication arrangement. These sizes are significantly narrower than conventional preforms for drawing into optical fibre, which typically have widths of the order of tens of millimetres. The narrow width of the thin preform enables the absence of pressurisation when drawing fibre from the thin preform, and also enables different handling of the thin preform before it is drawn to fibre, as will be discussed further below. Thin preform widths in this range, when drawn to fibres of conventional width, can yield fibre lengths of metres to hundreds of metres, for example between 4 m and 500 m of fibre, from one metre of thin preform. Thin preform total lengths around 10 km are envisaged, giving access to total fibre lengths of hundreds or thousands of kilometres. However, the invention is not limited in this way, and shorter lengths of fibre are useful and may be required in some cases, and longer lengths may be achievable depending on the parameters of the initial preform, the thin preform and the hollow core fibre, and the operational parameters of the drawing apparatus used. Practically, it is anticipated that minimum hollow core fibre lengths of at least 20 km will be routinely available, with lengths of 30 km or more, 50 km or more and 100 km or more readily attainable.

The thin preform has a length that comprises a total length available for drawing. The total length is very long compared lengths of conventional preforms and canes. Coupled with the narrow width of the thin preform, a large total volume of glass is made available in the thin preform, which enables extremely long lengths of fibre to be produced from the thin preform in a single draw despite a small drawdown ratio and a low fibre yield ratio. The thin preform length is defined as a total length available for drawing into the hollow core fibre, and can be provided in different ways. In some examples, the total length can be provided as a single span of thin preform so that the actual length of the thin preform equals the total length available for drawing into fibre before the fibre draw commences. In other examples, drawing of the fibre commences at a distal end of the thin preform before the thin preform has been made to the total length available for drawing, while the thin preform continues to be drawn from an initial preform at a proximal end (proximal and distal being defined with respect to the draw direction). In this case, the thin preform has a transient length between the proximal end where its glass is being replenished from the initial preform and the distal end where its glass is being consumed by the fibre. The transient length can be very much less than the total length available for drawing, but over the duration of the drawing process, the glass which has been made available for fibre drawing in the transient length accumulates until it corresponds to the total length. The thin preform's total length available for drawing into hollow core fibre can be as long as is convenient, depending on factors such as the required total length of hollow core fibre, the available operational time of the drawing apparatus, and the size of the initial preform from which the thin preform is drawn. However, in order to provide a useful improvement over the current limitations in hollow core fibre draw yields, the thin preform may have a total length available for drawing which is 30 m or more. Shorter lengths between about 10 m and 30 m are not excluded however, but more significantly, very much greater lengths can be implemented, in order to provide significant upscaling of hollow core fibre production. For high yield commercial fibre production, for example, the thin preform may have a length of at least 30 m, or at least 100 m, or least 1000 m (1 km), or at least 5000 m (5 km), or at least 50,000 m (50 km). An upper limit of length will be governed largely by practical reasons of handling (such as draw furnace size and speed of feeding and winding equipment) and fabrication time, rather than technical limitations. It is envisioned that readily producible and manageable lengths of thin preform might be in the range of 30-50 km, for example. The invention is not limited in this way, however, and other total lengths are not excluded.

For step S10, the thin preform can be provided by being obtained from elsewhere, by being fabricated separately to its total available length in a preceding stage of the fabrication process, or via a transient length. These alternatives will be described in more detail later.

The method proceeds to step S11, in which an end portion of the thin preform is heated to soften the glass, for example, in the furnace of a fibre draw tower in a conventional manner. In a next step S12, the hollow core fibre is drawn from the initial preform, the hollow core fibre having a width less than the width of the thin preform. Typical widths for hollow core fibre are in the range of 100 to 500 μm. This gives a drawdown ratio for drawing of the hollow core fibre from the thin preform, defined by the ratio of the thin preform cross-sectional area to the hollow core fibre cross-sectional area, in the range of about 4-500, or about 2 to 150, smaller than is conventionally used for hollow core fibre drawing. As discussed above, the low drawdown ratio allows the fibre to be drawn without the need for pressurisation to be applied to the voids of the thin preform. This is in contrast to the usual differential pressure applied when drawing hollow core fibre from preforms or canes. Accordingly, the fibre draw is able to be performed without any pressurisation being applied to the voids of the thin preform. However, the method is not limited in this way, and pressurisation may be applied to the thin preform voids in some circumstances if preferred. This might be during the draw process. Alternatively, pre-pressurisation stage might be implemented, in which gas at one or more different pressures is flowed into the voids of the thin preform so that the entire thin preform is pressurised, in advance before heating and the fibre draw, with a set of predefined pressures for the various voids. While it is not then possible to adjust the pressures or change any differential during the draw, modification of the temperature and tension during the draw can be carried out to universally alter the impact of the pre-applied pressure and hence control the internal structure of the fibre.

Any required length of hollow core fibre may be drawn from the thin preform, within the capacity of the glass available from the thin preform. For maximum efficiency, however, it is useful to draw the hollow core fibre in a continuous length until the available glass of the thin preform is exhausted, and the thin preform is fully consumed. Hence, the method may proceed to decision step S13, where it is determined whether or not the total length of the thin preform available for drawing has been drawn into the hollow core fibre. If yes, and the thin preform has been used up and there is none of the total length remaining, the method proceeds to step S14 in which the drawing of the fibre ceases, and the fibre is able to be separated from a remaining waste portion of the thin preform, not able to be made into fibre and hence not part of the total available length (as is usual in fibre fabrication where a certain amount of wasted glass is unavoidable, such as the neckdowns between two widths of glass structure). If no, and the thin preform has not yet been fully consumed, the method may loop back to step S11, where the end portion of the thin preform continues to be heated and drawn into fibre, as the thin preform is fed gradually into the furnace for heating, as is conventional.

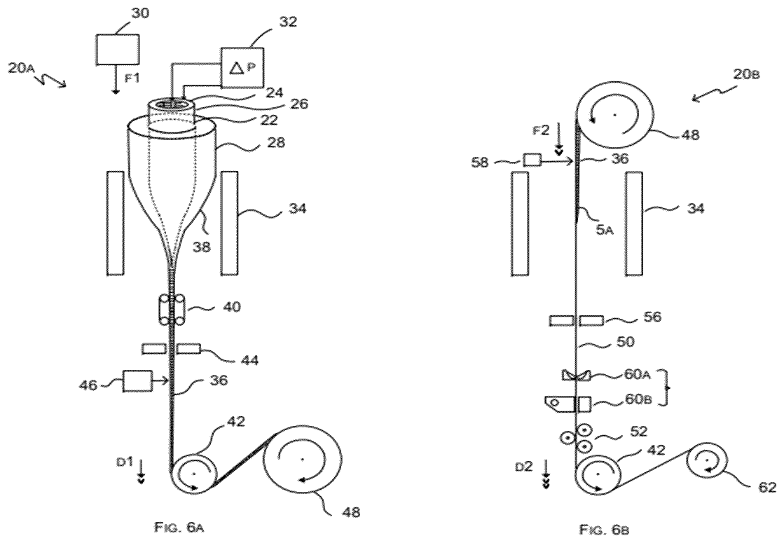

FIG. 5 shows a flow chart of steps in example methods for providing the thin preform in step S10 of the FIG. 4 method. As noted above, the thin preform may be provided in several ways. In situations where the thin preform is provided other than by passive obtainment from another source, the steps of the FIG. 5 method can precede the steps of the FIG. 4 method. In a first step S1, an initial preform is provided, which is formed from glass, and has a transverse cross-sectional structure configured to be drawn into the thin preform, providing the thin preform with a transverse cross-sectional structure for forming the final hollow core fibre, as described above. The initial preform may be a conventional preform such as a glass structure formed by stacking tubes and optionally other glass elements such as spacers inside an outer glass tube, as already described, or the initial preform may be a cane previously drawn from a conventional preform. The initial preform has a width greater than the intended width of the thin preform, which as already noted may be in the range of 0.5 mm to 5 mm. It is anticipated that a higher drawdown ratio might be used for making the thin preform than for making the hollow core fibre, for example in the range of 200 to 16000, where the drawdown ratio for this stage is the ratio of the initial preform cross-sectional area to the thin preform cross-sectional area. Accordingly, the initial preform may have a width in the range of about 20 mm to 200 mm. However, the invention is not limited in this regard, and other drawdown ratios and initial preform widths may be used, including a lower drawdown ratio than for the fibre draw stage, and larger initial preform widths in order to yield longer lengths of thin preform and subsequently hollow core fibre.

The use of a higher drawdown ratio for the thin preform fabrication allows standard hollow core preforms to be used as the initial preform, for example those which are conventionally drawn directly to fibre, or drawn into canes first. Conventionally, drawing a preform into a cane uses a relatively small drawdown ratio, and pressurisation is not required. Instead pressurisation is reserved from the cane-to-fibre drawdown. In the method proposed herein, however, pressurisation is to be applied to the initial preform when the thin preform is drawn from it, in order to obtain the transverse cross-sectional structure for the thin preform appropriate for drawing to fibre without the need for pressurisation being applied to the thin preform, as discussed above. The application of suitable pressurisation, including a differential pressure or pressures where different pressures are applied to different voids in the glass structure of a preform or cane, is a known technique for drawing optical fibre, and will not be described further herein since it can be implemented in the same or a similar way when drawing a thin preform from the initial preform. The skilled person is aware of how to apply appropriate pressures in order to obtain a desired target glass structure from an initial glass structure under the dynamics of pressurisation and surface tension contraction under drawing.

In a next step S2, an end portion of the initial preform is heated to soften the glass, for example using a furnace in a fibre draw tower. In step S3, the thin preform begins to be drawn from the softened glass of the initial preform while pressurisation is applied to voids of the initial preform. To enable the drawing of further thin preform, the initial preform is steadily fed to the furnace for heating and drawing, so that the glass of the initial preform is gradually consumed and converted to the thin preform, the length of which increases. After step S3, the method may follow one of two alternative paths, depending on the way in which the total length of thin preform available for drawing to fibre is to be provided.

In a first path, the method proceeds to step S4a. In this path, the entire length of the thin preform available for drawing into the hollow core optical fibre is made in a single draw, so that the actual length of the finished thin preform equals the total length available for fibre drawing. The total length can be very long, as noted above, and hence needs appropriate handling; this differs from handling of canes which are substantially rigid and very much shorter. Accordingly, in step S4a, the thin preform is collected by winding it onto a spool, drum or bobbin as it is drawn from the initial preform. This is in line with the collection of optical fibre in a conventional drawing process. The ability to collect the thin preform in a wound format, which is not possible with canes, is enabled by the narrow width of the thin preform, which makes it sufficiently flexible to be wound onto a spool without damage. The spool should have a diameter such that the curvature of its winding surface around which the thin preform is wrapped or coiled is equal too or greater than the bend radius of the thin preform, which in turn depends in part of the width of the thin preform. A smaller width provides a tighter bend radius, being the radius around with the thin preform can be bent before cracking or breaking.

In a next step S5a the thin preform continues to be drawn from the initial preform, as the initial preform continues to be fed to the furnace for heating. This proceeds until the length of the thin preform is the intended total length available for drawing into the hollow core fibre. This may be achieved before the initial preform is used up, but for maximum efficiency, the thin preform continues to the drawn until all the initial preform (minus wastage) has been converted into the thin preform. Once the total length of thin preform has been produced, the method proceeds to step S6a, in which the thin preform is separated from the remaining part of the initial preform. The thin preform is now stored on the spool, and is available for drawing into hollow core fibre according to the method of FIG. 4. This can be done immediately, or at a later time, and in the same draw tower or in a different draw tower. Finally, when required, the thin preform is provided for drawing hollow core optical fibre, as the first step S10 in the FIG. 4 method.

In order to protect the thin preform while it is being collected on the spool, stored on the spool and later unwound from the spool, a coating may be applied to it as it is fabricated, and before it reaches the spool. This can help protect against breaks and surface damage. The coating should be able to be removed from the thin preform before it is drawn into the hollow core fibre, although note that a separate protective coating may then be applied to the hollow core fibre after it has been drawn, which is conventional practice in fibre fabrication. Any coating which can be readily applied to and removed from the thin preform can be used. A first example is an ultraviolet-curable acrylate coating, which is of a type also used to coat optical fibres. This will provide good protection for the thin preform, but it adheres well to glass so may be too time-consuming and impractical to remove. An alternative is to extrude a polymer tube around the thin preform, by using, for example, a cross-head extruder. The polymer tube can be cut, peeled or torn off the thin preform as it is delivered for fibre drawing. The tube may have an inner diameter the same as the outer diameter of the thin preform so that it is in contact with, but not strongly adhering to, the outer surface of the thin preform, or it may have a larger inner diameter so that the thin preform is loose within the tube. The latter arrangement may facilitate cutting of the tube from the thin preform without damaging the thin preform's surface. A further alternative is apply a coating which is fugitive upon thermolysis (chemical decomposition by heating), for example as described in U.S. Pat. No. 5,596,669 [6]. This allows the coating to be removed as the thin preform passes through the furnace or is otherwise heated prior to fibre drawing.

In a second path of the FIG. 5 method, the process proceeds from step S3 to step S4b. In this path, the thin preform is formed as a transient length, which at any given time is much less than the intended total length available for drawing into the hollow core fibre. The transient length will depend on the configuration of the drawing apparatus used to produce the hollow core fibre; examples are described in more detail below. In step S4b, the length of the thin preform as drawn from the initial preform reaches the transient length, and, without separating the thin preform from the initial preform, the thin preform is provided for drawing into the hollow core fibre as in step S10 of the FIG. 4 method. In step S5b, the drawing of the thin preform from the initial preform continues while at the same time the hollow core fibre is drawn from the end of the thin preform (the distal end, remote from the neckdown between the initial preform and the thin preform). Hence, the thin preform is replenished at its proximal end and consumed from its distal end simultaneously, so that the transient length between these ends remains limited and substantially constant, but the total glass that has been comprised within the transient length between being added and then removed accumulates over time. This continues until the transient length has accumulated (in terms of the glass it has comprised) to the total length of the thin preform available for drawing into the hollow core fibre. In this way, the thin preform with a total length available for drawing required by step S10 of FIG. 4 is provided.

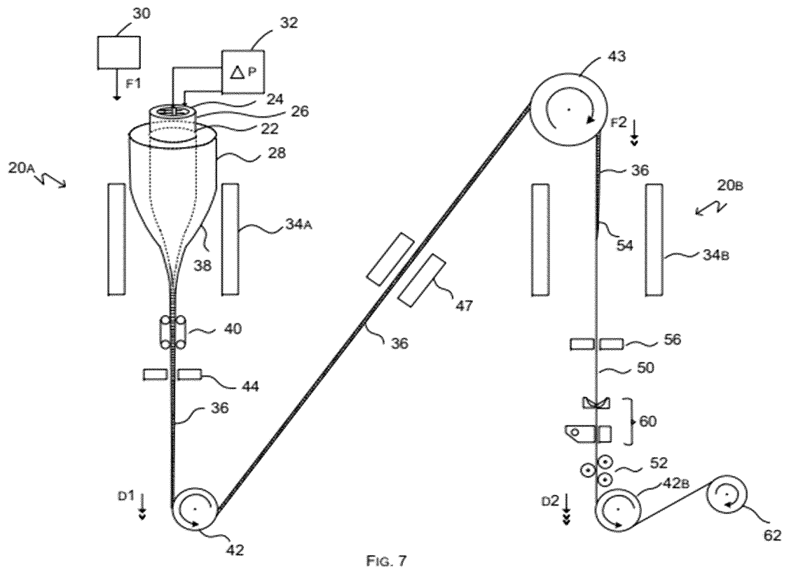

FIGS. 6A and 6B show a simplified schematic representation of an example apparatus suitable for carrying out an example hollow core optical fibre fabrication method according to the present disclosure. FIG. 6A shows apparatus in which a first part of the example method, corresponding to the first path of FIG. 5, namely steps S1 to S7a is being carried out. FIG. 6B shows apparatus in which a second part of the example method, corresponding to steps S10 to S14 of FIG. 4, is being carried out.

FIG. 6A shows an optical fibre drawing tower 20a, in which an initial preform is being drawn into a thin preform. An initial preform 22 has an initial preform width, and comprises in this example a ring of hollow capillary tubes 24 for forming a hollow core optical fibre microstructured cladding inside an outer glass support tube 26, arranged so as to define a void for forming a hollow core of the hollow core optical fibre within cladding. The initial preform 22 is surrounded by an outer glass layer 28 intended to form a glass jacket of the finished hollow core fibre, as described above. The initial preform is suspended at a first, upper end with its longitudinal axis vertical, from a support structure or rig (schematically shown as element 30), which is configured to feed the initial preform 22 and the outer glass layer 28 downwardly along the axial direction at a first feed speed F1. A pressurisation system 32 has connections to the core and cladding capillary voids of the initial preform in order to supply pressurised gas to the voids at one or more differential pressures ΔP, also as already described. The pressurisation is applied during drawing of a thin preform from the initial preform 22.

The drawing tower also comprises a vertically positioned annular furnace 34, in which the initial preform 22 is arranged such that a portion at its lower end is heated by the furnace in order to soften the glass of the end portion. The softened glass is drawn into a thin preform 36 with a thin preform width which is less than the initial preform width, via a neckdown 38 formed in the softened glass over which the width of the glass structure narrows from the initial preform width to the thin preform width. The softened glass is pulled downwards by the action of a belt puller 40 comprising a pair of facing vertically arranged endless belts between which the glass to form the thin preform is gripped and pulled downward by the rotation of the belts. After the belt puller 40 the thin preform 36 passes around a capstan 42 rotating in a vertical plane which also acts to pull the thin preform downwards so that it is continually drawn from the softened glass at the neckdown 38, which is in turn replenished from its upper end by the initial preform 28 being gradually fed into the furnace. The belt puller 40 and the capstan 42 act to tension the thin preform 36 so that it is pulled from the initial preform 22 at a constant rate, being a first draw speed D1, specified in order to form the thin preform 36 at the required width. The thin preform 36 is narrow enough that it is sufficiently flexible to be wound around a capstan for tensioning; note that this is not possible when drawing cane from a preform since cane is thicker and too rigid. Other tensioning devices may additionally or alternatively be used for this, according to known techniques for drawing optical fibres. The first draw speed D1 is faster than the first feed speed F1, in order to match the supply of newly softened glass from the relatively wide initial preform 22 to the uptake of softened glass by the relatively narrow thin preform, in order to provide the required drawdown ratio at the neckdown 38. The attainment of the required thin preform width may be aided by a first diameter gauge 44, in this example located between the belt puller 40 and the capstan 42, which comprises an aperture through which the drawn thin preform passes for diameter measurement by laser beams and from which results can be fed back to control the feed of the initial preform 22. Diameter gauges are also known in the art of fibre drawing. Also, an optional coating apparatus 46 is included below the diameter gauge 44, configured to provide an optional removable polymer coating onto the thin preform 36, according to any of the example coating methods already described.

The thin preform 36 passes around the capstan 42 and is taken up off the capstan 42 by a rotating spool, bobbin or drum 48, onto which the thin preform 36 is wound, by the action of the rotation. The drawing of the thin preform 36 can continue as long as required, up to and until the initial preform 22 is wholly consumed in that as much of the glass of the initial preform 22 as possible (minus unavoidable wastage) has been converted into the thin preform 36. The thin preform 36 collected on the spool 48 has an actual length which is a total length available for drawing into hollow core optical fibre. The wound thin preform 36 can be stored on the spool 48 for as long as is required, and need not be drawn down to fibre immediately. Accordingly, multiple spools of thin preform 36 might be successively drawn from one or more initial preforms while the drawing tower 20a is specifically configured for this process, in order to increase efficiency.

FIG. 6B shows an optical fibre drawing tower 20b, in which the previously fabricated thin preform 36 from FIG. 6A is being drawn into a hollow core optical fibre. The drawing tower 20b may be the same drawing tower 20a in which the thin preform 36 was drawn, but reconfigured for drawing of the fibre, or it may be a different drawing tower. The thin preform 36 is provided as it was wound onto the spool 48 during the thin preform drawing (or optionally rewound onto a different spool), and mounted above the furnace 34 of the drawing tower 20b. The furnace 34 of the drawing tower 20b may have the same specification as the furnace 34 of the FIG. 6A drawing tower, or it may differ, for example in temperature, length and/or internal diameter. A feed mechanism (not shown, either enabling a direct feed or comprising an arrangement of pulleys, dancers, accumulators and/or belt pullers to control the feed rate more precisely) is provided in order to pull the thin preform 36 from the spool 48 and feed the end portion of the thin preform 36 into the upper end of the furnace 34 at a feed speed F2. This differs from conventional drawing tower feed arrangements which are configured to handle short rigid preforms and canes that must be oriented and fed vertically; the long, thin and flexible format of the thin preform 36 enables it to be fed by unwinding from the spool 48 instead. An arrangement of one or more capstans or similar (not shown) may be included between the spool 48 and the furnace 34 in order to maintain the thin preform 36 at an optimum position within the furnace's heating zone as it is unwound from the spool 48. The feed speed F2 can be faster than the feed speed F1 used to feed the initial preform 22 into the furnace, since the drawdown ratio from thin preform to hollow core fibre is smaller, and it is generally desirable to produce optical fibre at as high a rate as possible Additionally or alternatively a lower furnace temperature might be used. The furnace 34 softens the glass of the end portion of the thin preform 36 so that a hollow core optical fibre 50 can be drawn from it. The fibre 50 is drawn under tension by passing out of the furnace 34 down to a capstan 42 located vertically below the furnace 34 and rotating in a vertical plane, around which the fibre 50 passes, via a tension gauge 52 located between the furnace 34 and the capstan 42 through which the fibre 50 passes, the tension being applied by the capstan 42. This tensioning arrangement pulls the fibre 50 at a second draw speed D2 from the softened glass of the thin preform 36 in the furnace 34, via a second neckdown 54 at which the width of the glass structure narrows from the thin preform width to the fibre width. The second draw speed D2, selected to achieve the required fibre width, is faster than the second feed speed F2, in order to match the supply of newly softened glass from the wider thin preform 36 as it is fed into the furnace to the uptake of softened glass by the narrower fibre 50, in order to provide the required drawdown ratio at the second neckdown 54. The attainment of the required fibre width may be aided by a second diameter gauge 56 which defines an aperture through which the drawn fibre 50 passes, in this example located below the furnace 34 before the fibre 50 reaches the tensioning elements 52 and the capstan 42.

Note that (in this example) no pressurisation is applied to the voids of the thin preform 36 while it is being drawn into the hollow core fibre 50. As described above, the small drawdown ratio for this drawing obviates the need for pressurisation. The lack of requirement for pressurisation enables the handling of extremely long lengths of thin preform, where any pressurisation applied at one end of a long thin preform would not be effective at its other end where the neckdown to fibre forms. The small diameter of the voids in the thin preform prevents the pressurising gas from propagating rapidly along the voids, so if the length is too great, pressurisation cannot be effective at counteracting surface tension during drawing. This is in contrast with a conventional hollow core fibre draw from a preform, in which the fibre structure can be monitored during drawing and the pressure adjusted to achieve the required geometry. With the longer and narrower thin preform, a change in applied pressure would not be expected to reach the neckdown region so that control of the geometry by pressurisation is not possible.

If a protective polymer coating has been provided for the thin preform 36 during its drawing, as described with regard to FIG. 6A, it is necessary to remove this from the thin preform 36 before it is drawn into the fibre 50. Thus, the drawing tower 20b may optionally include a coating removal device or apparatus 58 located above the furnace 34 configured to remove the coating, by a process depending on the nature of the coating. For example the coating removal device 58 may comprise one or more blades to engage with a tubular coating and slit it open as the thin preform passes the device 58, and means to take up the slit coating and pull it free from the thin preform 36, or a heat source to heat the passing fibre and thermolyse a fugitive coating. Alternatively, the heating provided by the furnace may be appropriate to remove a fugitive coating before the glass of the thin preform softens to form the second neckdown 54.

The drawing tower 20b may also optionally include a fibre coating apparatus 60, through which the fibre 50 passes after it is drawn, and in this case before reaching the tension gauge 52. Optical fibre conventionally is often provided with an outer coating, being a layer of material such as resin or polymer, after drawing in order to protect it from damage during subsequent storage and use. Accordingly, any known fibre coating apparatus may be used, and any known fibre coating may be applied. In this example, a ultraviolet curable coating is applied, such as an acrylate material, so that the apparatus 60 comprises a coating cup 60a containing a bath or reservoir of the coating material in liquid format through which the fibre 50 passes in order to collect a layer of the coating material on its outer surface, above a ultraviolet light source 60b which directs ultraviolet radiation on the layer of coating in order to cure and solidify it.

Finally, after passing around the capstan 42, the finished fibre 50 passes off the capstan 42 and is taken up and collected by being wound around a rotating fibre take-up spool, drum or bobbin, in the same manner as the thin preform 36 was collected from the first drawing stage. The drawing of the fibre 50 can continue as long as required, up to and until the thin preform 36 has been wholly consumed in that as much of the glass of the thin preform 36 as possible (minus avoidable wastage) has been converted into the hollow core fibre 50. This enables the longest possible continuous length of fibre to be fabricated if required, and maximises production efficiency in that a single fibre draw can produce a maximum length of fibre from a single thin preform. Overall, for maximum efficiency and maximum fibre span, the whole of the initial preform is drawn into the thin preform, and the whole of the thin preform is then drawn into the hollow core fibre.

Other example methods utilise the concept of the transient length of the thin preform explained above, in which the total available length of the thin preform is achieved by the constant addition of glass material at one end of the transient length at the same time as constant removal of glass material at the other end of the transient length. This avoids the need to collect and store the entire total available length of the thin preform. However, the process of drawing both to and from the thin preform at the same time requires two heat sources for softening the glass structure, in order to form the neckdown from initial preform to thin preform separately but simultaneously to the neckdown from thin preform to hollow core fibre. Examples of fibre drawing apparatus suitable for implementing this arrangement will now be described. In these apparatuses, hollow core fibre fabrication methods corresponding to the second path of FIG. 5, namely steps S1 to S5b, followed by steps S10 to S14 of FIG. 4 can be carried out.

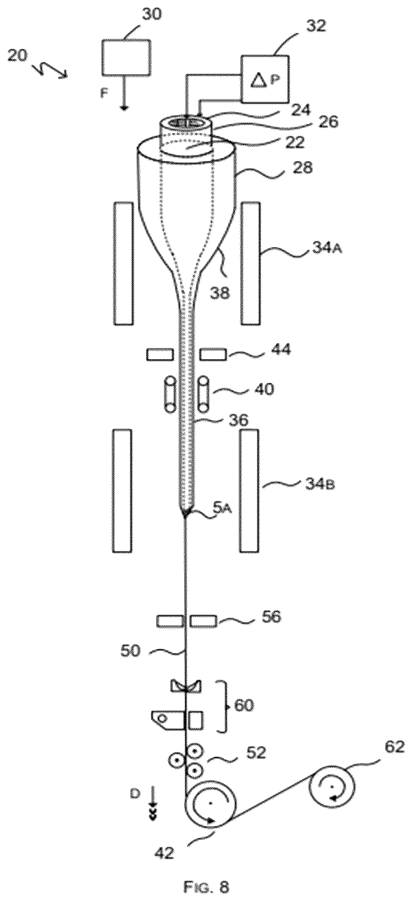

FIG. 7 shows a schematic representation of a first example apparatus for handling thin preform in a transient length format. The apparatus comprises two optical fibre drawing towers, 20a and 20b, which are laterally displaced from one another with respect to the vertical fibre drawing directions of the drawing towers 20a, 20b. The lateral displacement is partly for convenience, since the combined height of two drawing towers stacked vertically would be prohibitive in many environments, and also to aid isolation of tensioning and pressurisation between the two simultaneous draws. The addition of capstans and dancer wheels or similar feed control apparatus to route the preform from one drawing tower to the other decouples the two draws and inhibits the overall dynamics from behaving like a single draw in two stages. The first, left-hand drawing tower 20a is for performing drawing of the thin preform from the initial preform, and is configured substantially in the same manner as the drawing tower 20a of FIG. 6a, with like reference numerals being used to indicate like components. A detailed description will not therefore be repeated. In summary, however, an initial preform 22 configured as previously described is fed vertically into an annular draw furnace 34a of the first drawing tower 20a at a first feed speed F1, while a differential pressure is applied to its voids by a pressurisation system 32. The first furnace acts to soften the glass of the end portion of the initial preform 22, so that it can be drawn into the thin preform 36 via neckdown 38 under the tensioning and pulling action of a belt puller 40, the drawn thin preform passing through a thin preform diameter gauge 44 before being taken up by a vertically rotating capstan 42 (being a first capstan for handling the thin preform in this example) below the first furnace 34a, as before. The belt puller 40 and the first capstan 42 provide a first draw speed D1 for drawing the thin preform, which is faster than the first feed speed F1, again as before. Note that in the example, no thin preform coating apparatus 46 is included in the first drawing tower 20a. This is because the thin preform will not be collected and stored wound on a spool, but will instead immediately be drawn into hollow core fibre. Hence there is no need to provide the thin preform 36 with a protective coating.

In this example, however, after passing around the first capstan 42, the thin preform 36 is not collected on a spool for processing into hollow core fibre at some later time. Instead, once the thin preform has acquired a sufficient length to extend from the exit (at its base) of the first drawing tower 20a to the entrance (at its top) of the second drawing tower 20b, the thin preform is passed to a second capstan 43 above the furnace 34b of the second drawing tower 20b. An arrangement of capstans, dancer wheels, accumulators or similar feed control apparatus 47 (shown schematically as a block in FIG. 7) can be included between the capstans 42, 43, through or around which the thin preform 36 passes, in order to handle any slack in the thin preform 36 arising from perturbations in the capstan rotations that may cause variations in the instantaneous length of the thin preform 36 between the capstans 42, 43. Then, the second capstan 43 acts as a feed arrangement for the second drawing tower 20b, in place of take-off from the rotating spool 48 in FIG. 6B. Hence, the thin preform 36 passes over (possibly after one or more winds around) the second capstan 43 and is directed into the furnace 34b of the second drawing tower 20b for heating of its end portion. The remainder of the second drawing tower 20b is configured as the drawing tower of FIG. 6B, so that the softened thin preform 36 is drawn into hollow core fibre 50 via a second neckdown 54 in the furnace 34b and a fibre diameter gauge 56 via a tension gauge 52 and under tensioning from a fibre capstan 42b providing a draw speed D2. The fibre 50 is finally collected on a spool 62 after optionally receiving a protective coating at a coating apparatus 60. The first capstan 42 and the second capstan are rotated at appropriate speeds to maintain the first draw speed D1 and the second feed speed F2 substantially equal to one another, for smooth and continuous transfer of the thin preform 36 between the towers 20a, 20b (with assistance from the optional feed control apparatus 47). Note that there is no coating removal device 58 included above the furnace 34b in this example, because the thin preform has not been coated after drawing. However, in an alternative, a coating device for coating the thin preform 36 and a subsequent coating removal device may be included if preferred.

The length of the thin preform 36 extending from the first drawing tower 20a to the second drawing tower 20b, (measured, for example, from the exit of the first furnace 34a to the entrance of the second furnace 34b) is the transient length of the thin preform previously discussed. From FIG. 7, it can be readily appreciated that the proximal end of the thin preform 36 is continuously replenished with new glass from the drawdown of the initial preform 22, and the distal end of the thin preform 36 is continuously consumed as its glass is drawn down to the fibre 54. The transient length remains substantially constant (other than instantaneous variations caused by perturbations in the feed arrangements, to be handled by the feed control apparatus 47) while the glass material making up the thin preform travels along the transient length. Hence, in terms of the glass, the transient length accumulates over time to provide the total length of the thin preform 36 available for drawing into the hollow core fibre 50. In this configuration, the entirety of the initial preform 22 can be converted into a single continuous length of the hollow core fibre 50, via the thin preform 36, in a single fabrication process comprising two drawdown stages.

As with the FIG. 6B example, there is no pressurisation applied directly to the voids of the thin preform 36 during drawing of the hollow core fibre 50 from it. There is no free end of the thin preform 36 at the second drawing tower 20b at which to apply pressurisation if any was required, but since none is necessary, this is not a difficulty. The pressurisation applied to the voids of the initial preform 22 in the first drawing tower has no measurable effect at the second neckdown 54, because the length of the voids in the thin preform are too long and the width of the voids is too narrow for the applied gas to travel to the second neckdown in time to produce any significant or appreciable pressure at the location of the drawdown to fibre.

It will be appreciated from FIG. 7 that the transient length of the thin preform will be determined by the relative locations and physical arrangement of the first and second drawing towers 20a, 20b. However, given typical sizes and heights of fibre drawing towers, and noting that the first drawing tower might be a full size tower or a shorter tower, it is envisaged that transient lengths in the range of about 1 m to 100 metres may typically be utilised, although this is purely an exemplary range and the invention is not limited in this way. For example, if the first and second drawing towers are adjacent (transversely or laterally displaced), the transient length might be of the order of 5 m to 100 m, taking into account tower height, the horizontal distance from the first to the second tower, and the possible use of accumulators and the like between the drawing towers. If axially aligned towers are available, with less or no lateral displacement, the transient length might be 10 m or less, such as about 1 m to 5 m.

FIG. 8 shows a schematic representation of a second example apparatus for handling thin preform in a transient length format. In this example, the apparatus comprises just one optical fibre drawing tower 20, so that the overall draw from initial preform to hollow core fibre is carried out along a single vertical draw direction. However, the drawing tower 20 comprises two annular draw furnaces, a first, upper, furnace 34a and a second, lower, furnace 34b which are arranged axially aligned with one another along the draw direction with an axial spacing between them, but with no lateral displacement. The first furnace 34a is for performing drawing of the thin preform from the initial preform, and the second furnace 34b is for performing drawing of the hollow core fibre from the thin preform. Compared to the transversely spaced arrangement of the FIG. 7 example, different configurations are utilised to provide isolation of tensioning and pressurisation between the two simultaneous draws.

Many of the same components are present as in the first and second drawing towers of the FIG. 7 example, and like reference numerals are used; detailed description of these is therefore not repeated. An initial preform 22 configured as previously described is fed vertically into the first furnace 34a at a feed speed F, while a differential pressure is applied to its voids by a pressurisation system 32. The first furnace 34a acts to soften the glass of the end portion of the initial preform 22, so that it can be drawn into the thin preform 36 via neckdown 38 under the tensioning and pulling action of a belt puller 40 located below the first furnace 34a and above the second furnace 34b, after a thin preform diameter gauge 44. The belt puller 40 provides tensioning for the drawing of the thin preform 36 from the initial preform 22, and isolates this draw tension from the drawing of the fibre in the second furnace 34b. Again, no thin preform coating apparatus 46 is included since the thin preform is immediately be drawn into hollow core fibre, and requires no protective coating for storage.

As in the FIG. 7 example, when the thin preform 36 has acquired a sufficient length to extend from the exit of the first furnace to the entrance of the second furnace, the thin preform feeds directly vertically into the second furnace for heating of its end portion, without any directioning or steering. The remainder of the drawing tower 20 is configured as the second drawing tower of FIG. 7 from the second furnace 34b downwards, so that the softened thin preform 36 is drawn into hollow core fibre 50 via a second neckdown 54 in the second furnace 34b and a fibre diameter gauge 56 under tensioning from a fibre capstan 42 with a tension gauge 52 providing a draw speed D, and collected on a spool 62 after optionally receiving a protective coating at a coating apparatus 60. In the depicted arrangement, the belt puller 40 and the capstan 42 are operated to provide an increase in draw speed along the draw direction and hence maintain a first drawdown ratio at the first neckdown 38 and a second drawdown ratio at the second neckdown 54 in order to achieve a final draw speed D for the fibre 50. In order to isolate the tensions of the two draws, and possibly allow different draw speeds, additional tensioning elements (such as pulleys, dancers and/or accumulators, all known for handling optical fibre during drawing) may be included above the second furnace 34b to manage any slack, although this is less relevant than in the FIG. 7 example. This is possible owing to the narrow width of the thin preform and its resultant flexibility. Again, there is no coating removal device included above the second furnace 34b in this example, because the thin preform has not been coated after drawing.

The length of the thin preform 36 extending between the two neckdowns 38, 54 (measured, for example, from the exit of the first furnace 34a to the entrance of the second furnace 34b) is the transient length of the thin preform previously discussed. As in the FIG. 7 example, it can be readily appreciated from FIG. 8 that the proximal end of the thin preform 36 is continually replenished with new glass from the drawdown of the initial preform 22, and the distal end of the thin preform 36 is continually consumed as its glass is drawn down to the fibre 54. The transient length remains constant while the glass material making up the thin preform travels along the transient length. Hence, in terms of the glass, the transient length accumulates over time to provide the total length of the thin preform 36 available for drawing into the hollow core fibre 50. In this configuration, the entirety of the initial preform 22 can be converted into a single continuous length of the hollow core fibre 50, via the thin preform 36, in a single fabrication process comprising two drawdowns arranged along a single draw direction. It will be appreciated from FIG. 8 that the transient length of the thin preform will be determined by the relative axial displacement of the first and second furnace 34a, 34b, and can be made short or longer by separating the two furnaces by a lesser or greater amount. This may be determined at least in part by the vertical space available within the drawing tower 20 and the overall height which the drawing tower 20 is able to occupy. Typically, however, unless a large vertical space is available, it is expected that the maximum feasible transient length will be less in this example than in the FIG. 7 example. Given typical heights of fibre drawing towers, it is envisaged that transient lengths in the range of about 1 to 5 metres may typically be utilised, although this is purely an exemplary range and the invention is not limited in this way. Large industrial drawing towers can have a substantial height, so in some cases a transient length range of about 1 to 10 metres or 1 to 15 metres or more might be feasible. Usefully, a minimum transient length may be selected that allows sufficient cooling of the thin preform 36 that the belt puller 40 is not damaged by the hot glass, but overall a shorter transient length may be more convenient in reducing the total drawing tower height required.

As with the FIG. 6B and FIG. 7 examples, there is no pressurisation applied directly to the voids of the thin preform 36 during drawing of the hollow core fibre 50 from it. There is no free end of the thin preform 36 at the second drawing tower 20b at which to apply pressurisation if any was required, but since none is necessary, this is not a difficulty. However, since the transient length is relatively short in this example, there may be a concern that the pressurisation applied to the voids of the initial preform 22 may have a measurable effect at the second neckdown 54, causing unintended expansion of the internal geometry of the glass structure that will not be countered by surface tension in the fibre drawing. In order to address this, it is proposed that measures may be taken to isolate the lower drawdown in the second neckdown 54 from the pressurisation applied to the initial preform 22 for the upper drawdown in the first neckdown 38. The initial preform 22 may be fed into the first furnace 34a at a feed speed F and the applied gas from the pressurisation system 32 travels along the voids of the initial preform to the first neckdown 38 allowing control of the microstructure in thin preform 36. At the exit of the first furnace 34a the thin preform 36 is travelling fast so that the pressures applied to the initial preform are insufficient to flow gas at a speed matching the speed at which the voids are stretched within the first neckdown 38, such that the glass structure is able to “outrun” the gas, and arrive in the second furnace with little or no gas in the voids so that pressurisation is not present, or is negligible, in the second neckdown 54.

Further in this regard, and applicable to all examples, for a given width of hollow core fibre, a thinner thin preform allows a faster feed and draw to fibre owing to the smaller drawdown ratio, giving a better production efficiency. However, the higher feed speed requires a higher furnace temperature owing to the reduced dwell time, and the maximum achievable temperature for an existing furnace may therefore become a limiting factor when selecting a width at which to fabricate the thin preform. Accordingly, there may be a comprise to be struck in making the thin preform thinner or thicker. The use of existing fibre drawing apparatus may therefore impose parameters on implementing the methods described herein, whereas a new fibre drawing apparatus might be designed in order to maximise drawing efficiency and fibre output.

Although the methods have thus far been described as being performed in a conventional optical fibre drawing towers, the invention is not limited in this regard and the heating and drawing of the glass structures may be carried out using other apparatus as preferred. However, given the ability of the methods to increase fibre yield so that large continuous lengths of hollow core optical fibre can be readily produced, use of a drawing tower is particularly convenient. Indeed, a benefit of the proposed methods is that they can be readily implemented using conventional fibre drawing apparatus with only minor modifications.

A first further example provides a method of fabricating a hollow core optical fibre, the method comprising: providing a thin preform formed from glass and having a transverse cross-sectional structure configured to form, in a hollow core optical fibre drawn from the thin preform, a transverse cross-sectional structure comprising a hollow core surrounded by a plurality of voids defining a microstructured cladding, the thin preform have a width in the range of 0.5 mm to 5 mm and a total length available for drawing into the hollow core optical fibre; heating an end portion of the thin preform in order to soften the glass of the end portion; and drawing a length of hollow core optical fibre from the softened glass of the thin preform, the hollow core optical fibre having a width less than the width of the thin preform.

In the first further example, drawing the length of hollow core fibre may be carried out without applying pressurisation to voids in the thin preform during the drawing of the hollow core optical fibre.

In the first further example, the method may further comprise, before heating the end portion of the thin preform, flowing gas at one or more different pressures into voids in the thin preform in order to pre-pressure the thin preform.

In the first further example, drawing the length of hollow core optical fibre may comprise drawing the hollow core optical fibre until the total length of the thin preform available for drawing has been drawn into the hollow core fibre.

In the first further example, a drawdown ratio of a cross-sectional area of the thin preform to a cross-sectional area of the hollow core optical fibre may be in the range of 2 to 150.

In the first further example, the total length available for drawing may be 30 m or more.

In the first further example, the method may further comprise providing the thin preform by: providing an initial preform formed from glass and having a transverse cross-sectional structure configured to form the transverse cross-sectional structure of the thin preform when the thin preform is drawn from the initial preform with pressurisation of voids in the initial preform, the initial preform having a width greater than the width of the thin preform; applying pressurisation to the voids in the initial preform; heating an end portion of the initial preform in order to soften the glass of the end portion of the initial preform; and drawing the thin preform from the softened glass of the initial preform while the pressurisation is applied.

In the first further example, a drawdown ratio of a cross-sectional area of the initial preform to a cross-sectional area of the thin preform may be in the range of 200 to 16000.

In the first further example, the method may further comprise: collecting the thin preform as it is drawn by winding it onto a spool until the thin preform has a length equal to the total length available for drawing; and separating the thin preform from the initial preform.

In the first further example, the method may further comprise: applying a protective coating to the thin perform before the thin preform is wound onto the spool; and removing the protective coating from the thin preform before drawing the hollow core optical fibre from the thin preform.

In the first further example, the drawing of the hollow core fibre from the thin preform may be commenced while the thin preform is unitary with the initial preform and when the thin preform has reached a transient length less than the total length available for drawing, the drawing of the thin preform being continued during the drawing of the hollow core fibre so that the transient length is replenished from the initial preform until an accumulated transient length over a duration of the drawing equals the total length available for drawing.

In the first further example, the heating the end portion of the initial preform may be performed in a first furnace, and the heating the end portion of the thin preform may be performed in a second furnace laterally displaced, with respect to a drawing direction, from the first furnace.

In the first further example, the transient length of the thin preform, between an exit of the first furnace and an entry of the second furnace, may be in the range of 1 metre to 1000 metres.

In the first further example, the method may further comprise: controlling the tension of the thin preform between the first furnace and the second furnace so that tensioning used to draw the hollow core optical fibre from the thin preform is isolated from tensioning used to draw the thin preform from the initial preform.

In the first further example, heating the end portion of the initial preform may be performed in a first furnace, and the heating the end portion of the thin preform may be performed in a second furnace axially aligned, with respect to a drawing direction, with the first furnace.

In the first further example, the transient length of the thin preform, between an exit of the first furnace and an entry of the second furnace, may be in the range of 11 metre to 10 metres.

In the first further example, the method may further comprise: controlling the tension of the thin preform between the first furnace and the second furnace so that tensioning used to draw the hollow core optical fibre from the thin preform is isolated from tensioning used to draw the thin preform from the initial preform.

In the first further example, the method may further comprise: surrounding the initial preform with a glass outer layer before heating the end portion of the initial preform, so that the thin preform is drawn fused with the glass outer layer, the outer glass layer for forming a jacket for the hollow core optical fibre.

In the first further example, the transverse cross-sectional structure of the thin preform may be configured with a geometrical ratio that matches a geometrical ratio intended for the hollow core optical fibre plus a compensation amount to balance surface tension contraction of the softened glass of the thin preform during drawing of the hollow core fibre.

A second further example provides a method for fabricating a preform for a hollow core optical fibre, the method comprising: providing an initial preform formed from glass and having a transverse cross-sectional structure configured to form, in a thin preform drawn from the initial preform, a transverse cross-sectional structure able to be drawn from the thin preform into a hollow core optical fibre having a transverse cross-sectional structure comprising a hollow core surrounded by a plurality of voids defining a microstructured cladding, the initial preform having an initial preform width; applying pressurisation to voids in the initial preform; heating an end portion of the initial preform in order to soften the glass of the end portion of the initial preform; and drawing a thin preform from the softened glass of the initial preform while the pressurisation is applied, the thin preform having a width less than the initial preform width and in the range of 0.5 mm to 5 mm.

In the second further example, the method may further comprise: drawing the thin preform to a length of at least 30 m while collecting the thin preform on a spool, and separating the thin preform from the initial preform.

A third further example provides a thin preform formed from glass and having a transverse cross-sectional structure configured to form, in a hollow core optical fibre drawn from the thin preform, a transverse cross-sectional structure comprising a hollow core surrounded by a plurality of void defining a microstructured cladding, the thin preform have width in the range of 0.5 mm to 5 mm, and a length of at least 30 m.

In the third further example, the thin preform may be wound on a spool.

In the third further example, the thin preform may comprise a glass outer layer fused with the thin preform, for forming a jacket for the hollow core optical fibre.

In the third further example, the thin preform may comprise a protective coating which is able to be removed before the thin preform is drawn into the hollow core optical fibre.

A fourth further example provides a hollow core optical fibre having a transverse cross-sectional structure comprising a hollow core surrounded by a plurality of voids defining a microstructured cladding, the hollow core optical fibre having a length of at least 20 km.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] G T Jasion et al, “Fabrication of tubular anti-resonant hollow core fibers: modelling, draw dynamics and process optimization.” Opt. Express vol. 27, 20567-20582 (2019).
[2] Y Chen et al, “Multi-kilometer long, longitudinally uniform hollow core photonic bandgap fibers for broadband low latency data transmission,” IEEE JLT, 34, pp 104-113, (2016).
[3] U.S. Pat. No. 11,203,547
[4] S F Gao et al, “Hollow-core conjoined-tube negative-curvature fibre with ultralow loss”, Nat. Commun, 9, p 2828 (2018).
[5] CN 111474628
[6] U.S. Pat. No. 5,596,669

1. A method of fabricating a hollow core optical fibre, the method comprising:
providing a thin preform formed from glass and having a transverse cross-sectional structure configured to form, in a hollow core optical fibre drawn from the thin preform, a transverse cross-sectional structure comprising a hollow core surrounded by a plurality of voids defining a microstructured cladding, the thin preform have a width in the range of 0.5 mm to 5 mm and a total length available for drawing into the hollow core optical fibre;
heating an end portion of the thin preform in order to soften the glass of the end portion; and
drawing a length of hollow core optical fibre from the softened glass of the thin preform, the hollow core optical fibre having a width less than the width of the thin preform.

2. A method according to claim 1, wherein drawing the length of hollow core fibre is carried out without applying pressurisation to voids in the thin preform during the drawing of the hollow core optical fibre.

3. A method according to claim 1, further comprising, before heating the end portion of the thin preform, flowing gas at one or more different pressures into voids in the thin preform in order to pre-pressure the thin preform.

4. A method according to claim 1, wherein drawing the length of hollow core optical fibre comprises drawing the hollow core optical fibre until the total length of the thin preform available for drawing has been drawn into the hollow core fibre.

5. A method according to claim 1, wherein:
a drawdown ratio of a cross-sectional area of the thin preform to a cross-sectional area of the hollow core optical fibre is in the range of 2 to 150; and/or
the total length available for drawing is 30 m or more.

6. A method according to claim 1, further comprising providing the thin preform by:
providing an initial preform formed from glass and having a transverse cross-sectional structure configured to form the transverse cross-sectional structure of the thin preform when the thin preform is drawn from the initial preform with pressurisation of voids in the initial preform, the initial preform having a width greater than the width of the thin preform;
applying pressurisation to the voids in the initial preform;
heating an end portion of the initial preform in order to soften the glass of the end portion of the initial preform; and
drawing the thin preform from the softened glass of the initial preform while the pressurisation is applied.

7. A method according to claim 6, further comprising:
collecting the thin preform as it is drawn by winding it onto a spool until the thin preform has a length equal to the total length available for drawing; and
separating the thin preform from the initial preform.

8. A method according to claim 7, further comprising:
applying a protective coating to the thin perform before the thin preform is wound onto the spool; and
removing the protective coating from the thin preform before drawing the hollow core optical fibre from the thin preform.

9. A method according to claim 6, wherein the drawing of the hollow core fibre from the thin preform is commenced while the thin preform is unitary with the initial preform and when the thin preform has reached a transient length less than the total length available for drawing, the drawing of the thin preform being continued during the drawing of the hollow core fibre so that the transient length is replenished from the initial preform until an accumulated transient length over a duration of the drawing equals the total length available for drawing.

10. A method according to claim 9 wherein the heating the end portion of the initial preform is performed in a first furnace, and the heating the end portion of the thin preform is performed in a second furnace laterally displaced, with respect to a drawing direction, from the first furnace.

11. A method according to claim 10, further comprising controlling the tension of the thin preform between the first furnace and the second furnace so that tensioning used to draw the hollow core optical fibre from the thin preform is isolated from tensioning used to draw the thin preform from the initial preform.

12. A method according to claim 9, wherein heating the end portion of the initial preform is performed in a first furnace, and the heating the end portion of the thin preform is performed in a second furnace axially aligned, with respect to a drawing direction, with the first furnace.

13. A method according to claim 12, further comprising controlling the tension of the thin preform between the first furnace and the second furnace so that tensioning used to draw the hollow core optical fibre from the thin preform is isolated from tensioning used to draw the thin preform from the initial preform.

14. A method according to claim 6, further comprising surrounding the initial preform with a glass outer layer before heating the end portion of the initial preform, so that the thin preform is drawn fused with the glass outer layer, the outer glass layer for forming a jacket for the hollow core optical fibre.

15. A method according to claim 1, wherein the transverse cross-sectional structure of the thin preform is configured with a geometrical ratio that matches a geometrical ratio intended for the hollow core optical fibre plus a compensation amount to balance surface tension contraction of the softened glass of the thin preform during drawing of the hollow core fibre.

16. A method for fabricating a preform for a hollow core optical fibre, the method comprising:
providing an initial preform formed from glass and having a transverse cross-sectional structure configured to form, in a thin preform drawn from the initial preform, a transverse cross-sectional structure able to be drawn from the thin preform into a hollow core optical fibre having a transverse cross-sectional structure comprising a hollow core surrounded by a plurality of voids defining a microstructured cladding, the initial preform having an initial preform width;
applying pressurisation to voids in the initial preform;
heating an end portion of the initial preform in order to soften the glass of the end portion of the initial preform; and
drawing a thin preform from the softened glass of the initial preform while the pressurisation is applied, the thin preform having a width less than the initial preform width and in the range of 0.5 mm to 5 mm.

17. A method according to claim 16, comprising drawing the thin preform to a length of at least 30 m while collecting the thin preform on a spool, and separating the thin preform from the initial preform.

18. A thin preform formed from glass and having a transverse cross-sectional structure configured to form, in a hollow core optical fibre drawn from the thin preform, a transverse cross-sectional structure comprising a hollow core surrounded by a plurality of void defining a microstructured cladding, the thin preform have width in the range of 0.5 mm to 5 mm, and a length of at least 30 m.

19. A thin preform according to claim 18, comprising:
a glass outer layer fused with the thin preform, for forming a jacket for the hollow core optical fibre; and/or
a protective coating which is able to be removed before the thin preform is drawn into the hollow core optical fibre.

20. A hollow core optical fibre having a transverse cross-sectional structure comprising a hollow core surrounded by a plurality of voids defining a microstructured cladding, the hollow core optical fibre having a length of at least 20 km.
